(19) United States
(12) Patent Application Publication
(10) Pub. No.: US 2012/0166010 A1
(43) Pub. Date: Jun. 28, 2012

(54) DEVICES AND METHODS FOR APPLIANCE USAGE SCHEDULING AND CONTROL USING ON-LINE CALENDAR SERVICES WITH OPEN API

(75) Inventors: Pai-Hsiang CHOU, Taipei City (TW); Kuan-Hsun Wang, Taipei City (TW); An-Ping Wang, Hsinchu City (TW); Tsung-Hsiao Pan, Kaohsiung City (TW)

(73) Assignee: National Tsing Hua University, Hsinchu (TW)

(21) Appl. No.: 13/077,222

(22) Filed: Mar. 31, 2011

(30) Foreign Application Priority Data
Dec. 28, 2010 (TW) 099146212

(51) Int. Cl. G06F 1/26

(52) U.S. Cl. 700/296

(57) ABSTRACT

A device and method for appliance usage scheduling and control using on-line calendar services with open API is disclosed in embodiments of the present invention. The device includes an on-line calendar with open API, a control server and a sensor network. The on-line calendar sets date and time schedule according to a user setting to generate a control data packet corresponding to the schedule. The control server receives the control data packet by an internet and generates at least a control signal according to the control data packet. The sensor network communicates with an electronic appliance by radio frequency and controls actions according to the control signal.

### BACKGROUND OF THE INVENTION

(a) Field of the Invention

The invention relates to an automated home for appliance usage scheduling and control using an on-line calendar service with an open API (application programming interface).

(b) Description of the Related Art

In general, electronic appliance usage needs to be operated manually and cannot be remotely schedule control so that it is inconvenient for a user.

U.S. Pat. No. 7,310,344 discloses a method and system for an instant messenger home automation system interface using a home router and U.S. Pat. No. 7,403,838 discloses messaging system based building control. The messenger and instant messenger operate with home automation system can both achieve the purpose of instant control of electronic appliances. However, existing messenger and instant messenger remote control scheme still cannot provide appliance usage scheduling functions for a user. Thus it is still inconvenient for a user.

### BRIEF SUMMARY OF THE INVENTION

One object of the invention is to provide an home automation method and device using an on-line calendar service with an open API to schedule and control electronic appliance usage.

One object of the invention is to provide an electronic appliance control method and device to automatically control operation of the household appliances according to the schedule set in an on-line calendar.

One embodiment of the invention provides a device for appliance usage scheduling and control using an on-line calendar service with an open API. The device includes an on-line calendar with an open API, a home automation server and a sensor network. The on-line calendar with an open API generates at least a schedule corresponding to at least an event set by a user and generates an event data packet corresponding to the schedule according to request from the user. The home automation server receives the event data packet through an internet and generates at least a control signal according to the event data packet. The sensor network communicates with an electronic appliance through radio frequency and controls operation of the electronic appliance according to the control signal.

Furthermore, one embodiment of the invention provides a method for appliance usage scheduling and control using an on-line calendar service with an open API. The method comprises the following steps: a user interface operating step, an home automation server procedure checking step, an home automation server operating step, and a controlled appliance operating step. The user interface operating step comprises: logging in an on-line calendar with an open API; selecting an electronic appliance to be controlled, selecting an operating date and time of the electronic appliance, and selecting a function and signal of the electronic appliance to generate an event and uploading the event to the on-line calendar. The home automation server procedure checking step comprises: an on-line calendar login and downloading step, for logging in from the on-line calendar and downloading the event; comparing the date and time of the event with a current date and time; matching the event with a corresponding electronic appliance; analyzing the identity, function and signal of the electronic appliance; transmitting the data of the identity, function and signal of the electronic appliance to the home automation server; and waiting for a predetermined period of time and then repeating the procedure checking step. The home automation server operating step comprises: receiving a related signal from the procedure checking step wherein the related signal comprises one selected from the group consisting of the following or the combination thereof: the data of the event and the identity, function and signal of the electronic appliance; generating a transmission path of a control signal from the home automation server to control the electronic appliance; transmitting the control signal to the electronic appliance through radio frequency; and having the electronic appliance receive and be acknowledged the control signal. The controlled appliance operating step comprises: receiving the control signal by the home automation server; executing actions designated by the control signal; and replying a state update message of the electronic appliance to the home automation server.

The embodiments of the device and method according to the invention use an on-line calendar service with an open API and an electronic appliance control system to control the operation of the electronic appliance.

### BRIEF DESCRIPTION OF THE DRAWINGS

FIG. 1 shows a schematic diagram illustrating a cloud computing type electronic appliance control device according to one embodiment of the invention.

FIG. 2A shows a schematic diagram illustrating a local network being a sensor network according to one embodiment of the invention.

FIG. 2B shows a schematic diagram illustrating an home automation server according to one embodiment of the invention.

FIG. 3A shows a schematic diagram illustrating an application example of the device for appliance usage scheduling and control using an on-line calendar service with an open API according to one embodiment of the invention.

FIG. 3B shows a schematic diagram illustrating a schedule Sc set by a user according to one embodiment of the invention.

FIG. 4 shows a flow chart illustrating a method for appliance usage scheduling and control using an on-line calendar service with an open API according to one embodiment of the invention.

FIG. 5A shows a flow chart illustrating the user interface operating step according to one embodiment of the invention.

FIG. 5B shows a flow chart illustrating the home automation server procedure checking step according to one embodiment of the invention.

FIG. 5C shows a flow chart illustrating the home automation server operating step according to one embodiment of the invention.

FIG. 5D shows a flow chart illustrating the controlled appliance operating step according to one embodiment of the invention.

### DETAILED DESCRIPTION OF THE INVENTION

The following will describe embodiments of the invention together with the accompanying drawings and each embodiment can be implemented. Besides, the well known details will not be given hereinafter to prevent from blurring the key of the invention. Each embodiment does not need to be excluded from others and can combine with other embodiment(s) to comprise one embodiment of the invention. The following will describe a number of embodiments of the invention and various modifications or changes can be made by those who are skilled in the art without deviating from the spirit of the invention. The invention should not be restricted into the following embodiments or the characteristics described in the following.

The present invention discloses a device and method for appliance usage scheduling and control using an on-line calendar service with an open API. The following embodiments use a google on-line calendar with open API as examples but the present invention is not limited to these examples. Various current on-line calendars with open APIs or on-line calendars with open APIs to be developed in the future are applicable to the techniques of the invention.

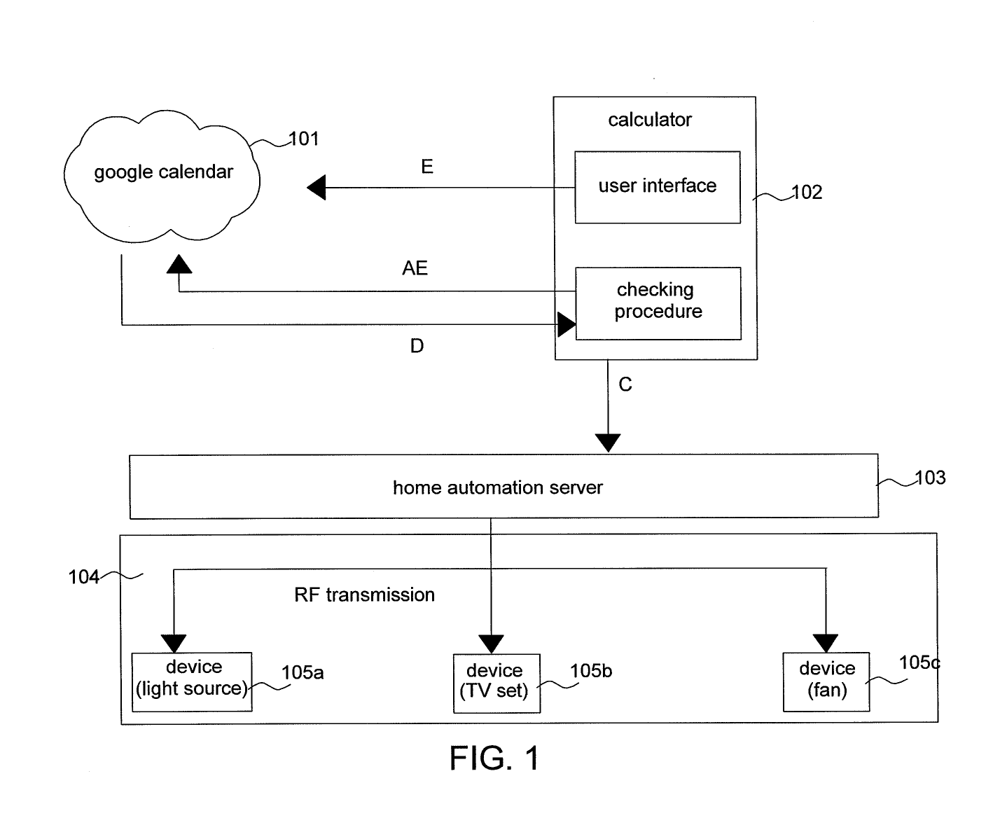

FIG. 1 shows a schematic diagram illustrating a device for appliance usage scheduling and control using an on-line calendar service with an open API according to one embodiment of the invention. The device 100 includes a calculator 102, a google calendar 101 with an open API, a home automation server 103, and a local network 104.

The calculator 102 includes a user interface and a checking procedure. A user may set data of a schedule as an event E in the google calendar to control electronic appliances. The event E may comprise one of the following or combination thereof: date, time, which device to be controlled, setting data of a signal.

The checking procedure may generate an inquiry data AE to ask the google calendar for events of home automation control. The checking procedure may receive an event data packet D from the google calendar. It should be noted that in one embodiment, the user interface can simultaneously operate with two or more than two calendars with open APIs.

A user may operate the calculator 102 to set a schedule including at least an event for home automation. The calculator 102 then generates an event E to the google calendar 101 with an open API. Further, the google calendar 101 generates the event data packet D according to the event E corresponding to the request of the user.

In one embodiment, the home automation server 103 receives at least a control signal C event data packet via a network event data packet. In one embodiment, the checking procedure of calculator 102 generates the control signal C according to the event data packet D. Then the home automation server 103 transmits the control signal C to the local network 104. In another embodiment, the home automation server 103 may receive and process the event data packet D to generate the control signal Cevent data packet directly through the google calendar 101.

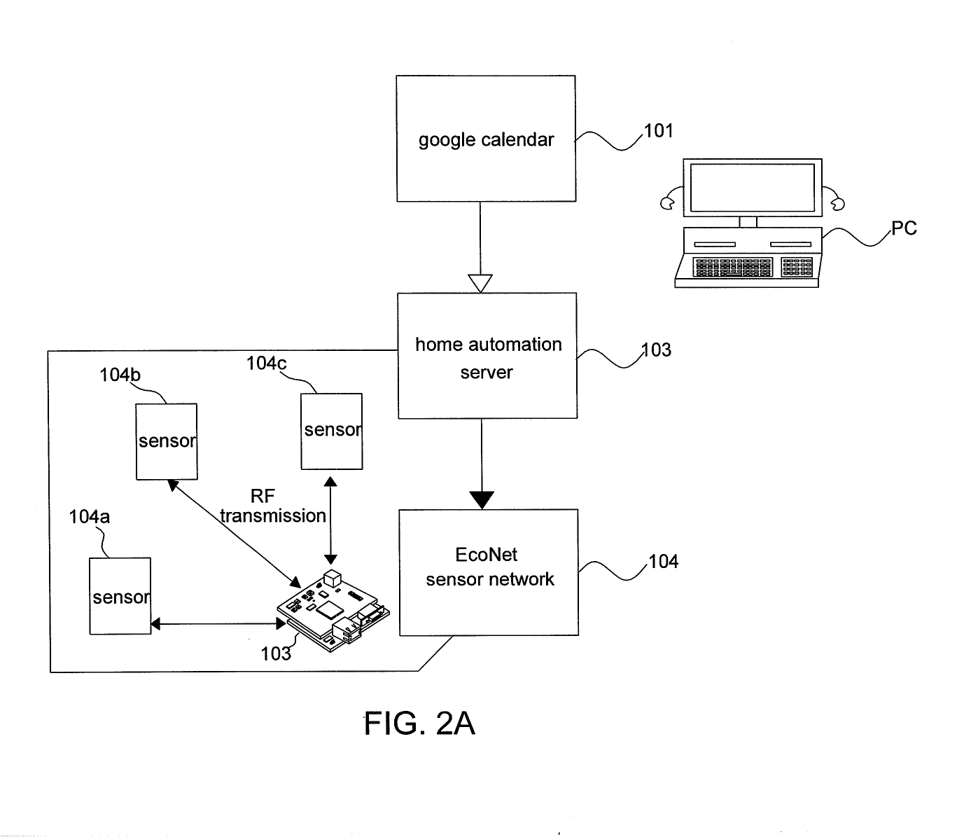

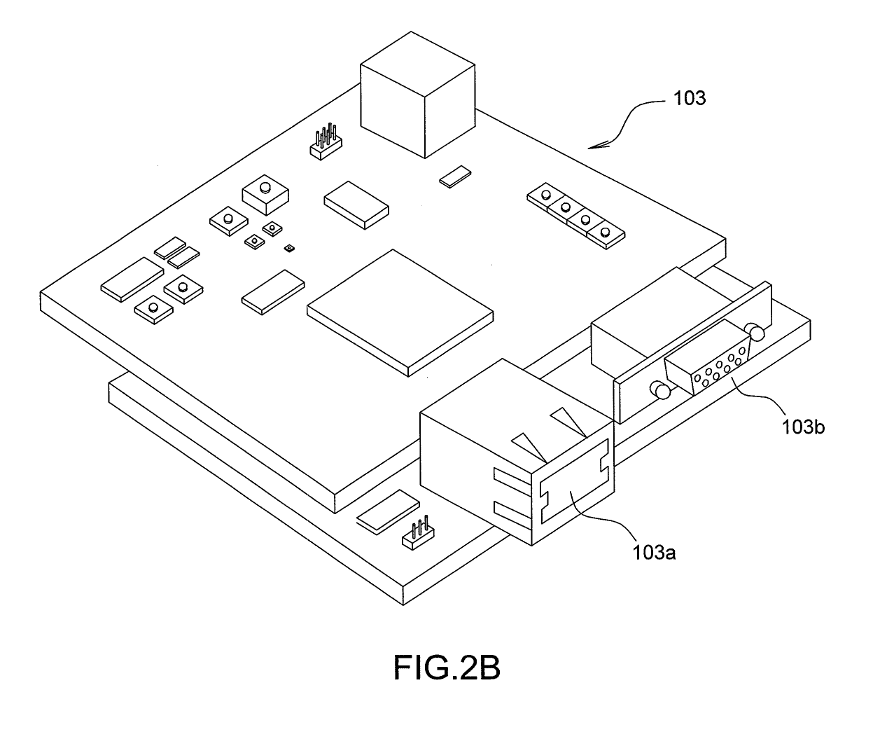

The local network 104 may communicate with at least an electronic appliance 105 (105a˜105b) or control the operation of the device (electronic appliance) 105 (105a˜105b) according to the control signal C by a wired or wireless method. For example, the devices may be examples: the light source 105a, the TV set 105b and the fan 105c as shown in FIG. 1. The network 104 may communicate with or control at least an electronic appliance 105 through RF (radio frequency) transmission channel as shown in FIG. 1. As shown in FIG. 2A, the local network 104 may be a sensor network, such as an ECO sensor network (it should be noted that ECO is a wireless sensor platform developed by the applicant himself where ECO is the exact word but not abbreviation). The sensor network 104 includes a plurality of sensors. The sensors, coupled the electronic appliances, communicates with the home automation server through RF channel. The sensors provide the operation state of the electronic appliances to the home automation server 103 or receive signals from the home automation server 103 to execute operations in the schedule, such as turning on/off or controlling the electronic appliance (for example, various operations like adjusting the magnitude of the electric energy, controlling the fan to rotate slower or faster, etc.).

The home automation server may be a e butler server. In one embodiment, the home automation server may be implemented on a microcontroller evaluation board having a serial peripheral interface (SPI), such as Freescale M52259DEMOKIT, shown in FIG. 2B. The home automation server is not limited to be the microcontroller evaluation board having a serial peripheral interface (SPI) from Freescale. The home automation server may also be an embedded system development kit from other companies. As long as the embedded system development kit has a serial peripheral interface (SPI) and supports a network function, the system of the invention can be implemented thereon. That is, the invention can be implemented on any current embedded system or any embedded system to be developed in the future.

The e butler server uses a polling mechanism to constantly check if any event is triggered in the schedule of google calendar. If the e butler server receives the event data packet D from the network, it indicates an event is triggered and then the control module of the e butler server is initiated according to the event data packet D. Further, the e butler server generates at least a control signal C to communicate with or control the sensor through RF, thereby controlling functions of the electronic appliance. Thus the operation of each electronic appliance can be controlled according to the schedule on the on-line calendar.

As shown in FIG. 2B, the e butler server includes a network connector 103a and a signal transmission connector 103b. The network connector may be an Ethernet connector RJ45, . . . any current or future developed data transmission connector. The signal transmission connector 103b, coupled to the calculator 102, may be a universal serial bus RS232, any current or future developed signal transmission connector.

It should be noted that the home automation server 103 and the sensor network 104 may be integrated into a product. Further, the event data packet D may be transmitted to the home automation server 103 through one of the following or combination thereof: personal computer PC and google calendar 101.

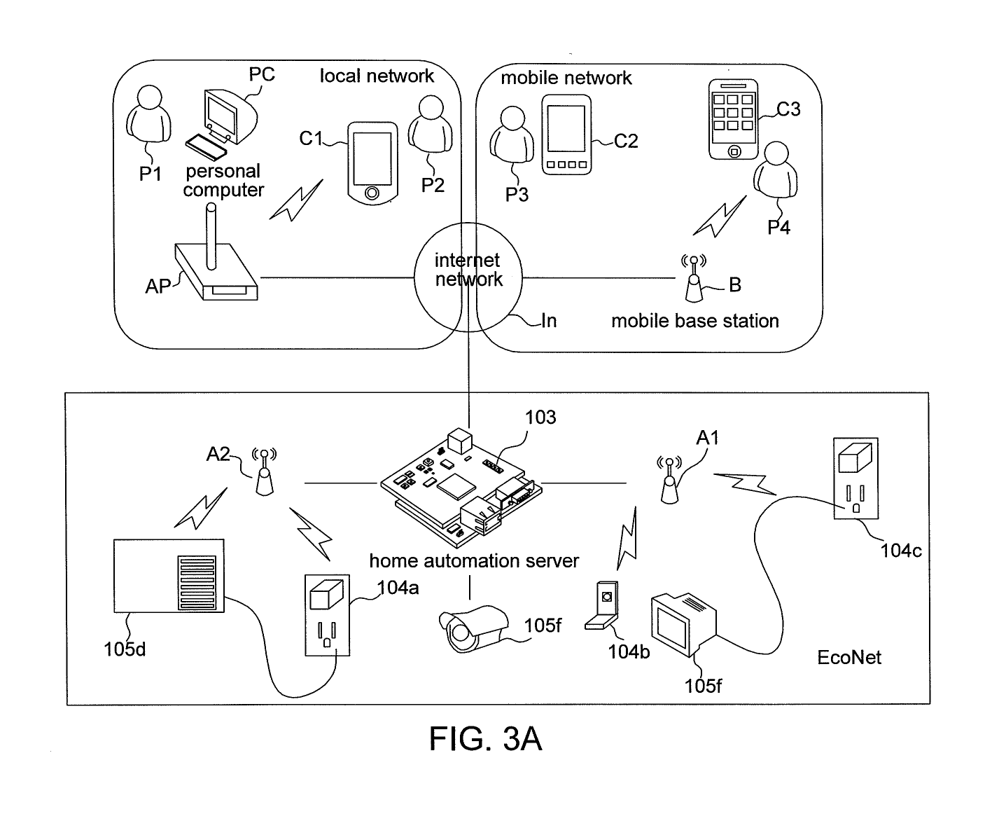

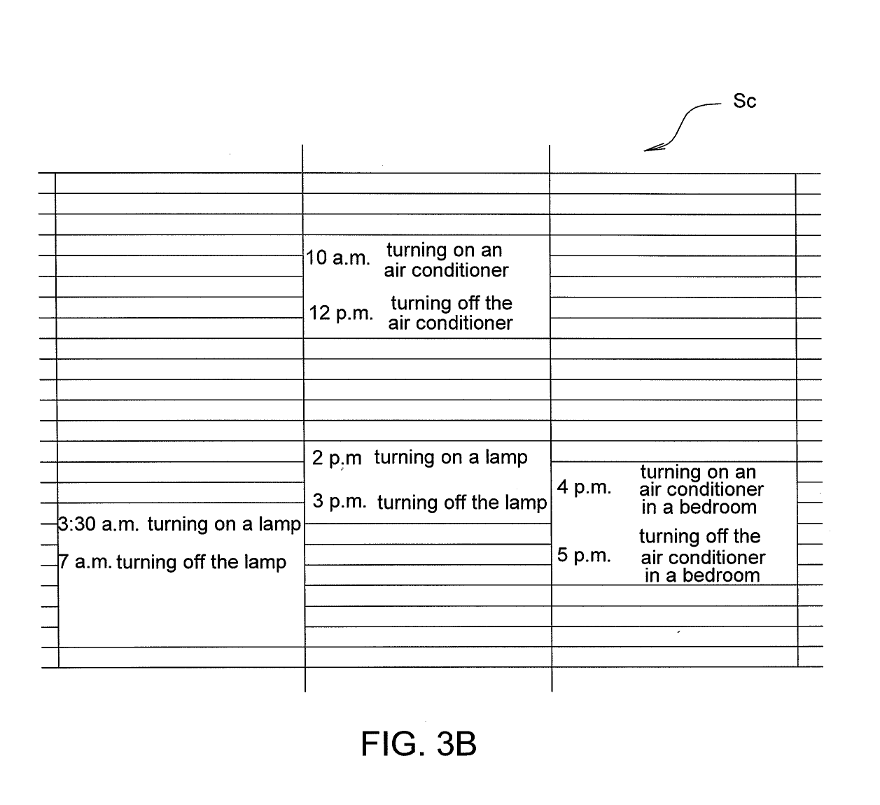

Please refer to FIG. 3A and FIG. 3B. FIG. 3A shows a schematic diagram illustrating an application example for appliance usage scheduling using an on-line calendar service with an open API. FIG. 3B shows a schematic diagram illustrating an example schedule Sc set by a user.

At first, it is assumed that “schedule start time” is the time turning on an electronic appliance and “schedule end time” is the time turning off the electronic appliance. A user may be informed of and control the setting of each electronic appliance by the display of the schedule Sc. Thus a user may remotely control the current state of each electronic appliance.

For example, as shown in FIG. 3A, users P1 and P2 separately use a calculator (such as a personal computer or a laptop computer) and a portable device C1 to communicate with the access point AP (such as IP sharing device, router, etc.) in a local network via a wired or wireless path. Then, the users P1 and P2 communicate with the home automation server 103 (e butler server) through an internet network In. Users P3 and P4 separately use the portable devices C2, C3 of different systems (such as Android system or Apple platform) to communicate with the mobile base station B in a mobile network (such as 3G network, etc.) to thereby connect to the internet network In. Thus portable devices C2, C3 may communicate with the home automation server 103. As shown in FIG. 3A, the sensors 104a, 104b, 104f are coupled to the electronic appliances 105d, 105e, 105f. Then the home automation server 103 may turn on/off the electronic appliances 105d 105e, 105f through the interior transmission base station A1 or A2 (such as wireless broadcasting base station, . . . , etc.). It should be noted that in one embodiment each of the above sensors may be a switch to control electrical power or may be other form to adjust the operation of the electronic appliance.

A scene is assumed. In a hot summer, a user comes home at 7 p.m. every day and then turns on an air conditioner and a lamp in the living room. At 9 p.m., the air conditioner is turned off and at 11 p.m. the lamp in the living room is turned off and a table lamp is turned on. At the time, the user may input data of a schedule Sc (such as set “schedule start time” of the lamp to 3:30 pm and “the schedule end time” to 7:00 pm) into the google calendar 101. Then the home automation server 103 will automatically control the switches of the electronic appliances to let the air conditioner and the lamp already turned on at the time before user arrives home. If the user has to work overtime one day and will be home very late, the user only needs to use his mobile phone to connect to internet to delete the schedule of turning on the air conditioner and the lamp or to postpone the schedule.

It should be noted that according to one embodiment of the invention the user may set a schedule of any day or days within one year and the format of the schedule Sc may be adjusted according to the designer or needs of the user.

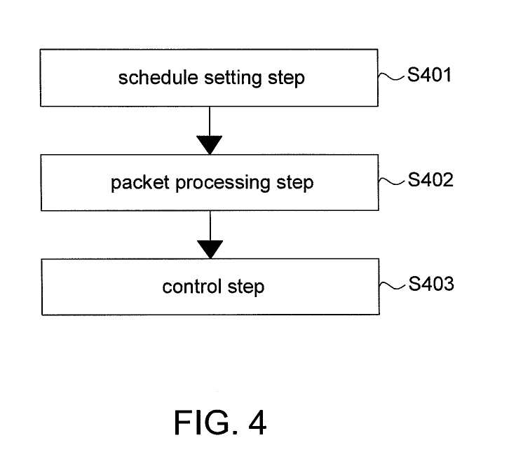

FIG. 4 shows a flow chart illustrating a method for home automation scheduling using an on-line calendar service with an open API according to one embodiment of the invention.

The method includes steps S401, S402 and S403 as follows: The step S401: schedule setting step, for providing an on-line calendar with an open API, generating at least a schedule corresponding to at least an event set by a user, and generating an event data packet corresponding to the schedule wherein the on-line calendar with an open API may be a google calendar.

The step S402: packet processing step, for using a network to receive the event data packet and generating at least a corresponding control signal according to the event data packet. Using a polling mechanism checks that if the event data packet from the network is received.

The step S403: control step, for controlling an operation of at least an electronic appliance according to the at least a control signal.

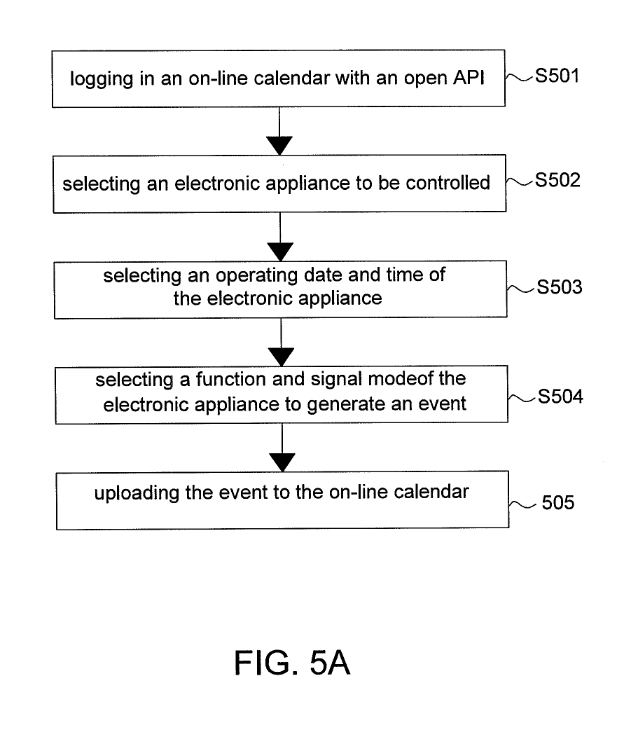

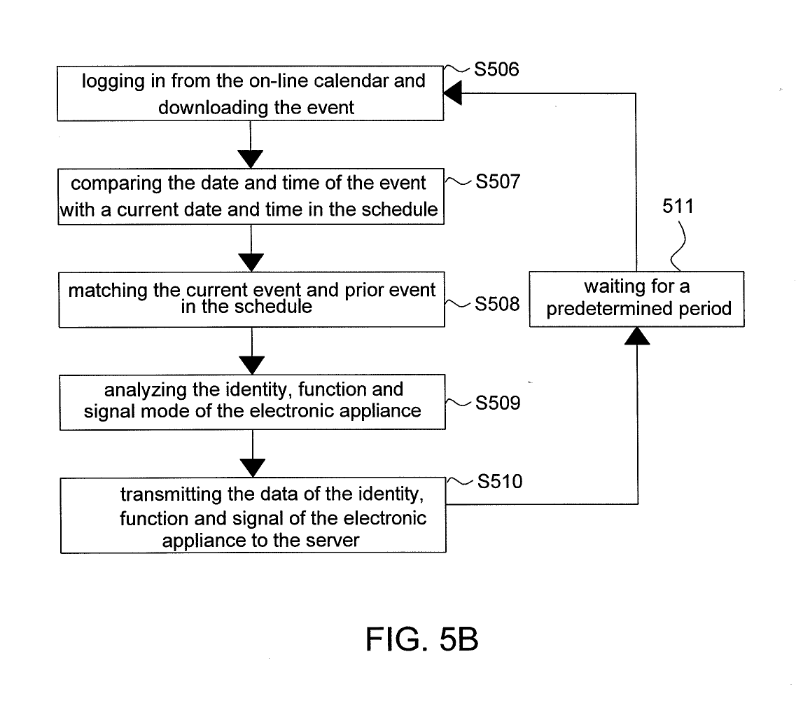

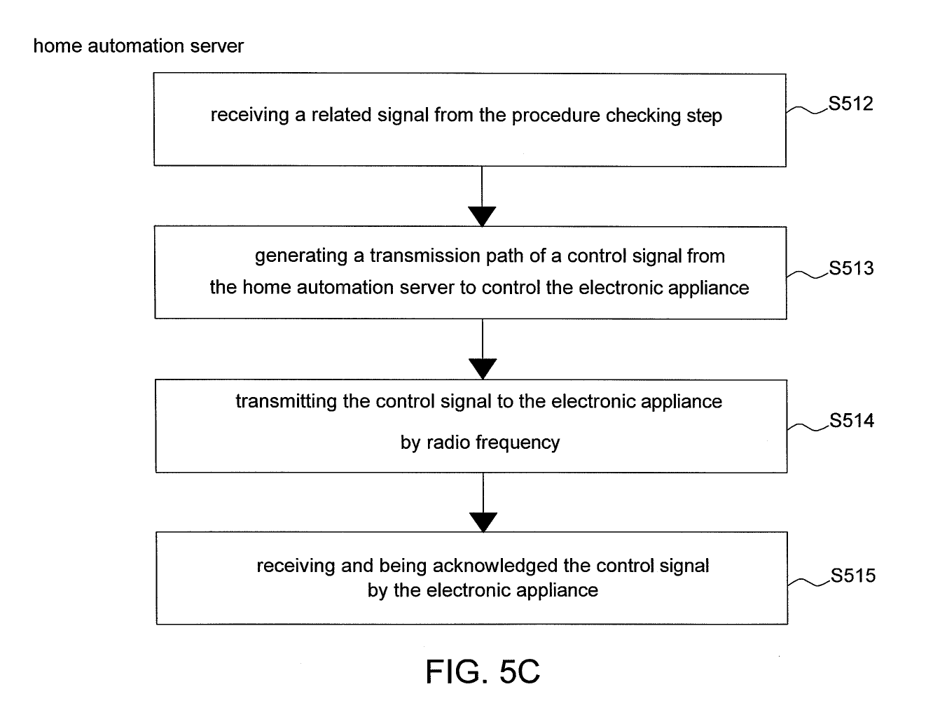

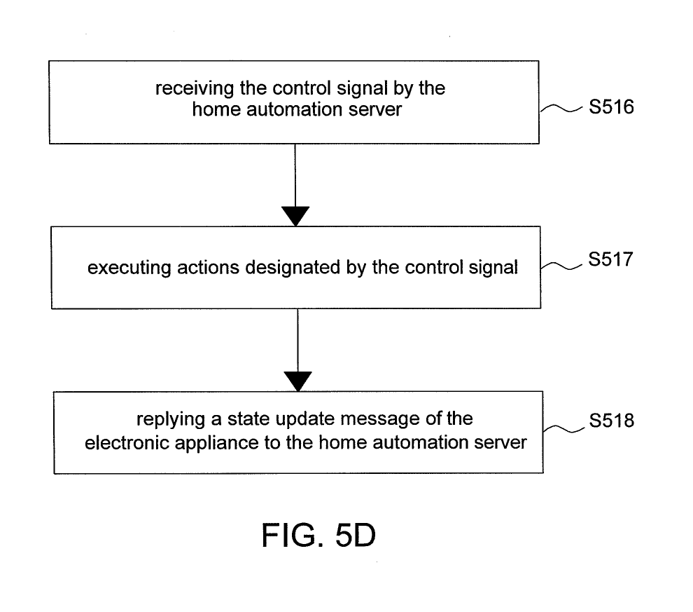

FIGS. 5A, 5B, 5C, and 5D show flow charts illustrating a method for appliance usage scheduling using an on-line calendar service with an open API according to an embodiment of the invention.

As shown in FIG. 5A, the user interface operating step includes:

Step S501: logging in an on-line calendar with an open API;

Step S502: selecting an electronic appliance to be controlled;

Step S503: selecting an operating date and time of the electronic appliance;

Step S504: selecting a function and signal mode of the electronic appliance to generate an event; and

Step S505: uploading the event to the on-line calendar.

As shown in FIG. 5B, the home automation server procedure checking step includes:

Step S506: logging in from the on-line calendar and downloading the event;

Step S507: comparing the date and time of the event with a current date and time in the schedule;

Step S508: matching the current event and prior event in the schedule;

Step S509: analyzing the identity, function and signal mode of the electronic appliance;

Step S510: transmitting the data of the identity, function and signal of the electronic appliance to the server; and

Step S511: waiting for a predetermined period and going back to the step S506.

As shown in FIG. 5C, the home automation server operating step includes:

Step S512: receiving a related signal from the procedure checking step (such as identity, function, and signal);

Step S513: generating a transmission path of a control signal from the home automation server to control the electronic appliance;

Step S514: transmitting the control signal to the electronic appliance by radio frequency; and

Step S515: receiving and being acknowledged the control signal by the electronic appliance.

As shown in FIG. 5D, the controlled appliance operating step includes:

Step S516: receiving the control signal by the home automation server;

Step S517: executing actions designated by the control signal; and

Step S518: replying a state update message of the electronic appliance to the home automation server.

A user may input a schedule into an on-line calendar with an open API. The device and method of the embodiments of invention may automatically control the operations of the electronic appliances according to the schedule to turn on/off electronic appliances. Thus the user can remotely control the electronic appliances according a schedule and problems in prior arts can be solved.

Although the present invention has been fully described by the above embodiments, the embodiments should not constitute the limitation of the scope of the invention. Various modifications or changes can be made by those who are skilled in the art without deviating from the spirit of the invention. Any embodiment or claim of the present invention does not need to reach all the disclosed objects, advantages, and uniqueness of the invention. Besides, the abstract and the title are only used for assisting the search of the patent documentation and should not be construed as any limitation on the implementation range of the invention.

What is claimed is:

1. A home automation device using an on-line calendar with an open API, comprising:
an on-line calendar with an open API, for generating an event data packet corresponding to at least an event in a schedule;
a home automation server, for generating at least a control signal according to the event data packet received from an interne; and
a local network, for communicating with an electronic appliance and controlling operation of the electronic appliance according to the control signal.

2. The device according to claim 1, wherein the on-line calendar with an open API is a google on-line calendar.

3. The device according to claim 1, wherein the local network is a sensor network.

4. The device according to claim 1, wherein the local network communicates with at least an electronic appliance by radio frequency and controls operation of the electronic appliance according to the control signal.

5. The device according to claim 1, wherein the electronic appliance is a household electronic device.

6. The device according to claim 1, further comprising a calculator, providing an operating interface to have a user set data in the schedule.

7. The device according to claim 1, wherein the home automation server uses an alternating inquiry mechanism to poll whether an event is activated or not.

8. A method for appliance usage scheduling and control using an on-line calendar service with an open API, comprising:
a schedule setting step, for providing an on-line calendar with an open API and generating an event data packet corresponding to a schedule set by a user in the on-line calendar;
a packet processing step, for receiving the event data packet through a network and generating at least a corresponding control signal according to the event data packet; and
a control step, for controlling at least an electronic appliance according to the control signal.

9. The method according to claim 8, wherein the packet processing step uses an alternating inquiry mechanism to poll whether an event is activated or not.

10. The method according to claim 8, wherein the on-line calendar with an open API is a google on-line calendar.

11. A method for appliance usage scheduling and control using an on-line calendar service with an open API, comprising:
a user interface operating step, comprising:
logging in an on-line calendar with an open API;
selecting an electronic appliance to be controlled, selecting an operating date and time of the electronic appliance, and selecting a function and signal mode of the electronic appliance to generate an event; and
uploading the event to the on-line calendar;
a home automation server procedure checking step, comprising:
an on-line calendar login and downloading step, for logging in the on-line calendar and downloading the event;
comparing the date and time of the event with a current date and time;
matching the event with a corresponding electronic appliance;
analyzing the identity, function and signal mode of the electronic appliance;
transmitting the data of the identity, function and signal mode of the electronic appliance to the home automation server; and
waiting for a predetermined period and repeating the procedure checking step;
an home automation server operating step, comprises:
receiving a related signal from the procedure checking step wherein the related signal comprises one selected from the group consisting of the following or the combination thereof: the data of the event and the identity, function and signal mode of the electronic appliance;
generating a transmission path of a control signal from the home automation server to control the electronic appliance;
transmitting the control signal to the electronic appliance by radio frequency; and
receiving and being acknowledged the control signal by the electronic appliance;
and
a controlled appliance operating step, comprising:
receiving the control signal by the home automation server;
executing actions designated by the control signal; and
replying a state update message of the electronic appliance to the home automation server.

12. The method according to claim 11, wherein the on-line calendar with an open API is a google on-line calendar.
